(19) United States
(12) Patent Application Publication
(10) Pub. No.: US 2003/0171976 A1
(43) Pub. Date: Sep. 11, 2003

(54) Method and system for assessing customer experience performance

(76) Inventors: Christopher D. Farnes, Spokane, WA (US); Ronald C. Benton, Camas, WA (US); Lynda D. Davis, Boise, ID (US); Robert A. Horenstein, San Jose, CA (US); Thomas B. Rideout, Snohomish, WA (US)

Correspondence Address: HEWLETT-PACKARD COMPANY, Intellectual Property Administration, P.O. Box 272400, Fort Colllins, CO, 80527-2400, US

(21) Appl. No.: 10/094,034

(22) Filed: Mar. 7, 2002

(51) Int. Cl. G06F 17/60

(52) U.S. Cl. 705/10

(57) ABSTRACT

A method for assessing performance of a customer experience of an organization. Survey data from at least one survey is compiled, wherein the survey is comprised of questions corresponding to a core competency and wherein the questions are divided into question groups such that each question group corresponds to one of a plurality of customer experience management capabilities. The survey data is analyzed wherein at least one of the customer experience management capabilities is analyzed according to a corresponding maturity level.

### FIELD OF INVENTION

The present invention relates to the field of customer experience.

### BACKGROUND OF THE INVENTION

There are many business organizations that exist within the United States and throughout the world. Any one of these business organizations may include any number of employees, from a very small number to several thousands or even hundreds of thousands. Furthermore, business organizations may include many different sub-organizations and departments that produce a wide variety of products and/or services. Additionally, business organizations may have facilities and employees that are distributed in many different locations throughout a country or the world. It is appreciated that business organizations provides many different benefits to their customers and local communities.

Notwithstanding these benefits, it is also understood that there are disadvantages associated with business organizations. In general, business organizations struggle with understanding what their role is and what proper focus is required to have the desired impact. For example, business organizations may have a difficult time determining whether they are providing a satisfactory level of service and/or products to their customers. Additionally, another disadvantage associated with a business organization is that it may be more difficult to determine if changes within particular departments will actually improve their customers' overall experience. As such, there have been different solutions utilized in order to remedy some of the disadvantages associated with business organizations.

One suggested solution provides businesses and/or organizations a total customer experience (TCE) framework for providing a superior customer experience at the organization level, with success measured in terms of actual impact on customers. TCE framework is interested in all aspects of a customer's relationship with the organization, including the organization's image development, product or service selection, ordering a product or service, using a product or service, support of a product or service, upgrading or evolving a product or service, disposal of a product or service, etc.

In order to provide a superior TCE, a business or organization must understand and analyze its current performance with respect to the customer experience. In particular, the TCE framework aids in identifying the “critical few” highest leverage improvement opportunities with respect to providing superior TCE. One of the focuses of the TCE framework is on developing the organization's customer experience management capabilities as well as addressing critical customer loyalty and satisfaction issues.

Current approaches to assessing the performance of TCE are ad hoc, assigning a person or group to do some level of investigation. However, there are disadvantages with ad hoc approaches to determining current TCE performance.

One disadvantage with current ad hoc approaches is that they typically lack representation from various levels and across various departments. For example, an organization may only assess the current performance of one department, only consider the input of employees having direct contact with customers. This approach fails to consider the impact of other levels of employees and other departments on delivering TCE.

Another disadvantage with current approaches is that they are typically qualitative in nature. Qualitative analysis of an organization's TCE performance, relying on subjective information, approaches are much more susceptible to human bias and emotional responses. Thus, the reliability and usefulness of such information is suspect.

Yet another disadvantage with current approaches is that they rely on a bottom-up approach to organizational change. For example, employees with direct customer contact recognize flaws and try to drive change up through the organization. Typically, the changes promoted by low-level employees lack management support, and thus do not have the resources to be successful.

### SUMMARY OF THE INVENTION

A method for assessing performance of a customer experience of an organization. Survey data from at least one survey is compiled, wherein the survey is comprised of questions corresponding to a core competency and wherein the questions are divided into question groups such that each question group corresponds to one of a plurality of customer experience management capabilities. The survey data is analyzed wherein at least one of the customer experience management capabilities is analyzed according to a corresponding maturity level.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a flowchart of steps in a process for implementing total customer experience action planning in accordance with one embodiment of the present invention.

FIG. 2 is a flowchart of steps in a process for assessing performance of a total customer experience of an organization in accordance with one embodiment of the present invention.

FIG. 3 shows an exemplary total customer experience capability assessment in accordance with one embodiment of the present invention.

FIG. 4 shows a plurality of customer experience management capabilities in accordance with one embodiment of the present invention.

FIG. 5 shows the relationship between two versions of a maturity framework, in accordance with one embodiment of the present invention.

FIG. 6 is an illustration of an exemplary performance profile showing a maturity level and an importance level of a plurality of customer experience management capabilities, in accordance with one embodiment of the present invention.

FIG. 7 is an illustration of an exemplary core competency profile for a customer experience management capability showing a performance level of each core competency within the customer experience management capability, in accordance with one embodiment of the present invention.

### BEST MODE(S) FOR CARRYING OUT THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and the scope of the invention as defined by the appended claims. Furthermore, in the following detailed description of the present invention, numerous specific details are set forth in order to provide a thorough understanding of the present invention.

Some portions of the detailed descriptions which follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels and are to be interpreted further in view of terms commonly used in the art. Unless specifically stated otherwise as apparent from the following discussions, it is understood that throughout discussions of the present invention, discussions utilizing terms such as “identifying” or “compiling” or “analyzing” or “generating” or “providing” or the like, may refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

Portions of the present invention are comprised of computer-readable and computer executable instructions which reside, for example, in computer-usable media of a computer system. It is appreciated that the present invention can operate within a number of different computing devices (e.g., server computer, portable computing device, desktop computer, etc.). Within the following discussions of the present invention, certain processes and steps are discussed that are realized, in one embodiment, as a series of instructions (e.g., software program) that reside within computer readable memory units of a computer system and executed by a processor(s) of the computer system. When executed, the instructions cause computer system to perform specific actions and exhibit specific behavior which is described in detail below.

In one embodiment, the computer system comprises an address/data bus for communicating information, one or more central processors coupled with the bus for processing information and instructions. The central processor unit(s) may be a microprocessor or any other type of processor. The computer system also includes data storage features such as a computer usable volatile memory unit (e.g., random access memory, static RAM, dynamic RAM, etc.) coupled with the bus for storing information and instructions for the central processor(s) and a computer usable non-volatile memory unit (e.g., read only memory, programmable ROM, flash memory, EPROM, EEPROM, etc.) coupled with the bus for storing static information and instructions for the central processor(s). The computer system also includes one or more signal generating and receiving devices coupled with the bus for enabling the computer system to interface with other electronic devices and computer systems. The communication interface(s) of the present embodiment may include wired and/or wireless communication technology. For example, within the present embodiment, the communication interface is a serial communication port, but could also alternatively be any of a number of well known communication standards and protocols, e.g., Universal Serial Bus (USB), Ethernet, FireWire (IEEE 1394), parallel, small computer system interface (SCSI), infrared (IR) communication, Bluetooth wireless communication, broadband, and the like.

Optionally, the computer system may include an alphanumeric input device including alphanumeric and function keys coupled to the bus for communicating information and command selections to the central processor(s). The computer system can include an optional cursor control or cursor directing device coupled to the bus for communicating user input information and command selections to the central processor(s). The cursor directing device can be implemented using a number of well known devices such as a mouse, a track-ball, a track-pad, an optical tracking device, a touch screen, etc. Alternatively, it is appreciated that a cursor can be directed and/or activated via input from the alphanumeric input device using special keys and key sequence commands. The present embodiment is also well suited to directing a cursor by other means such as, for example, voice commands. The computer system can also include a computer usable mass data storage device such as a magnetic or optical disk and disk drive (e.g., hard drive or floppy diskette) coupled with the bus for storing information and instructions. An optional display device is coupled to the bus for displaying video and/or graphics. It should be appreciated that the optional display device may be a cathode ray tube (CRT), flat panel liquid crystal display (LCD), field emission display (FED), plasma display or any other display device suitable for displaying video and/or graphic images and alphanumeric characters recognizable to a user.

Portions of the present invention are operated in the context of a network of computer systems as described above. Within a computer network, the users of a plurality of computer systems may readily exchange files, share information stored on a common database, pool resources, and communicate via electronic mail (e-mail) and video teleconferencing. Specifically, networked computer systems are each communicatively coupled to a local area network (LAN). It should be appreciated that networked computer systems of the present embodiment are well suited to be communicatively coupled in a wide variety of implementations. For example, the computer systems may be coupled via coaxial cable, copper wire, fiber optics, wireless communication, and the like. Furthermore, the computer systems of the present embodiment may also be communicatively coupled via a wide area network (WAN), e.g., the Internet.

Within a computer network, it is understood that computer systems may each be implemented in a manner similar to the above described computer system. Additionally, it should be appreciated that a computer network is well suited to have any number of computer systems communicatively coupled together. The computer systems of the present embodiment are well suited to be located within the same building, within different buildings of a company campus, or anywhere throughout the world.

### Exemplary Total Customer Experience Action Planning Process

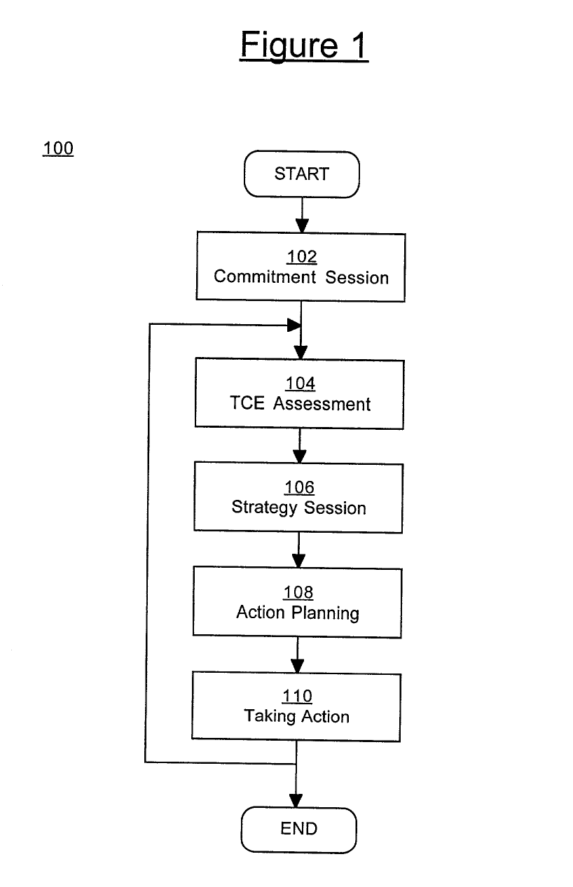

FIG. 1 is a flowchart 100 of steps for implementing an exemplary total customer experience (TCE) action planning within which embodiments of the present invention may be implemented. The exemplary TCE action planning process may be implemented within, but is not limited to, an organization at its sub-organization level. For example, an organization may have two or more different sub-organizations that each have a different business focus. Additionally, each sub-organization includes all of the associated business components for addressing their particular business focus. However, it is understood that the TCE action planning process may be implemented within any type of organization or business (e.g., for-profit, non-profit and governmental).

The exemplary TCE action planning process provides businesses and/or organizations with a method for providing high customer value through a systematic approach of setting goals and strategies based on customers, partners and internal measures and linking these measures to implementation metrics. Specifically, total customer experience (TCE) strategic planning is a means to “operationalize” efforts in order to provide a superior customer experience at the organization level wherein success is measured in terms of actual impact on customers. Through the TCE process, strategies and metrics are developed based on objective assessments of the organization's current TCE performance by customers, partners and internal sources rather than subjective introspection. This methodology begins by engaging organization leadership in a process that allows them to rapidly identify and focus on the “critical few” customer improvements required for their future business success. One of the focuses of the TCE action planning process is on developing the organization's management capabilities regarding all of the things which are performed within the organization that ultimately have an effect on the customer experience. Furthermore, another focus of TCE action planning is addressing critical customer loyalty and satisfaction issues.

The TCE action planning process of the present embodiment may provide many different advantages to an organization and/or business. For example, the TCE process specifically engages organization leadership in TCE improvement programs. Furthermore, the TCE planning process provides tops-down management and accountability of TCE improvement programs. Additionally, the TCE process provides continuous linkage from strategic goals and metrics to implementation of specific success metrics. Another advantage of the TCE process is that it provides management with the complete performance picture needed to identify and address the highest-return customer issues. Moreover, the TCE action planning provides a process for TCE delivery system partners to work together in order to set and align their strategies.

At step 102 of FIG. 1, within the present embodiment, a commitment session is conducted which is a meeting that provides an overview of the TCE action planning process by clarifying the objectives, sponsorship and importance of the program for the organization. For example, the participants of the commitment session are provided with a clear understanding of the process and deliverables, the roles they will play and what will be expected of them as they work to develop TCE as a core competency within the organization.

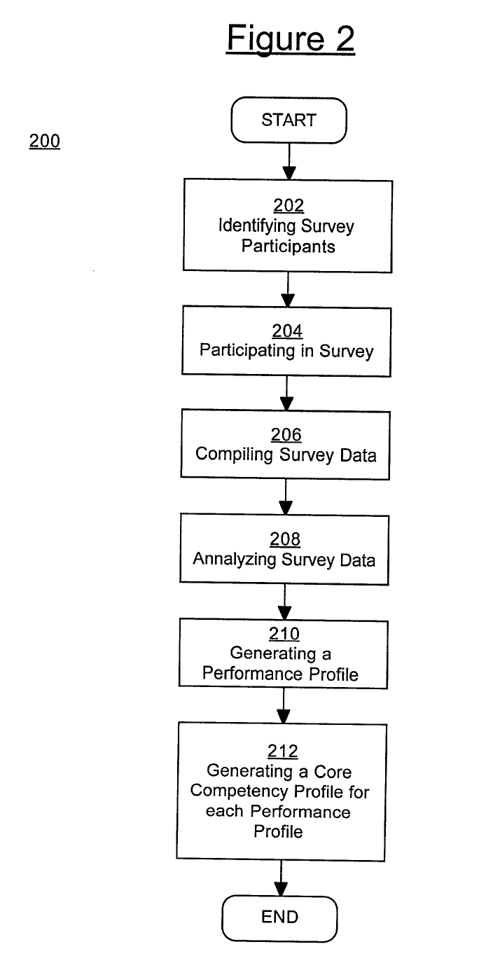

At step 104, within the present embodiment, a TCE assessment process is performed where data associated with customer loyalty, satisfaction and their total customer experience (TCE) are gathered. During the TCE assessment process, in one embodiment, participants within the organization complete a survey (e.g., a questionnaire) assessing the organization's current performance in the areas critical to their TCE success. Embodiments of a TCE assessment are described in detail at FIG. 2. It should be appreciated that the data from these surveys are analyzed and presented during an upcoming strategy session (e.g., at step 106) in order to focus the discussions of the critical TCE improvement opportunities.

At step 106 of FIG. 1, within the present embodiment, a strategy session is conducted in order to identify which aspects of the customer focus are most critical to their business success and discussing the organization's current performance in these areas. Within one embodiment of step 106, the objectives of the strategy session process may be to focus on critical issues of the organization, set TCE goals, identify goal owners, and kick-off the action planning process of step 108.

In step 108 of FIG. 1, within the present embodiment, the action planning process is conducted wherein each TCE goal owner is facilitated as needed through the process of leading extended staff and key individuals in setting appropriate action plans for achieving goals. That is, each action plan, success criteria and measurement methods are defined for tracking progress toward the goal.

At step 110 of FIG. 1, within the present embodiment, a taking action process is implemented wherein action plans are implemented in order to achieve the TCE goals. Within the taking action process of step 110, the progress is measured and tracked against the previously specified success criteria and customer data. Additionally, during the taking action process, on-going consultation by those familiar with the TCE action planning process 100 may be provided as needed in areas such as: customer experience planning and design, value delivery system analysis and mapping, and customer satisfaction and loyalty measurement and analysis.

### Method for Assessing Performance of a Customer Experience of an organization

FIG. 2 is a flowchart 200 illustrating steps in a process for assessing performance of a total customer experience of an organization in accordance with one embodiment of the present invention. Flowchart 200 includes processes of the present invention which, in one embodiment, are carried out by processors and electrical components under the control of computer readable and computer executable instructions. The computer readable and computer executable instructions reside, for example, in data storage features such as a computer usable volatile memory and/or computer usable non-volatile memory. However, the computer readable and computer executable instructions may reside in any type of computer readable medium. Although specific steps are disclosed in flowchart 200, such steps are exemplary. That is, the present invention is well suited to performing various other steps or variations of the steps recited in FIG. 2. Within the present embodiment, it should be appreciated that the steps of flowchart 200 may be performed by humans, by software, by hardware or by any combination of humans, software and/or hardware.

At 202 of FIG. 2, survey participants are identified. In the present embodiment, the survey participants are selected from employees of the organization providing a customer experience. In one embodiment, the survey participants include both management and non-management positions. It should be appreciated that employees may be paid employees or volunteers. It should also be appreciated that employees providing a customer experience includes all employees whose work contacts or influences a customer experience. For example, employees involved in production, marketing, sales and research and development provide a customer experience. Essentially, an employee whose work can affect a customer's opinion of the organization provides a customer experience.

In one embodiment, in identifying survey participants, it is important to understand the organization enough to identify customer relevant departments. In order to ensure a beneficial TCE performance assessment, it is desirable to identify all customer relevant departments to ensure meaningful representation.

In one embodiment, a sample of all employees in customer relevant departments is selected. The selected sample of employees can be any size, and can be determined using any sampling technique. In one embodiment, the selected survey participants are notified as to their selection to participate in the survey.

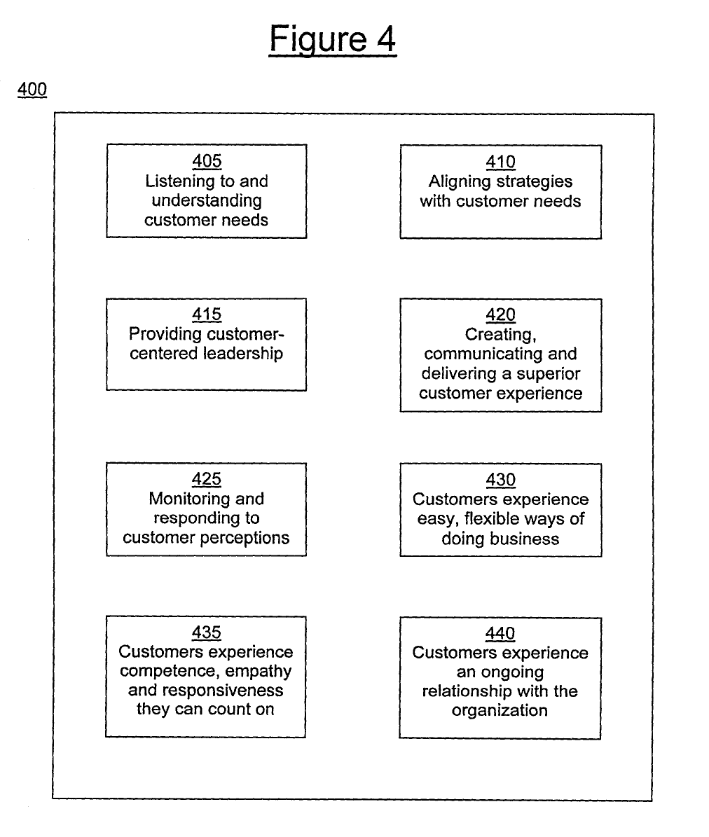

At step 204, the survey participants participate in the survey for assessing the organization's TCE performance. The survey provides an instrument used across an organization to capture information about current performance and attitudes. In one embodiment, the survey is used to efficiently gather the data needed to characterize the organization's current customer experience management capabilities and its critical improvement opportunities based on future business needs. In one embodiment, the TCE assessment is based on performance of a plurality of customer experience management capabilities. A customer experience management capability is an identified area of customer experience. In one embodiment, there are eight customer experience management capabilities, as shown at customer experience management capabilities 400 of FIG. 4, and listed as follows:

1. Listening to and understanding customer needs 405: The ability to systematically acquire, internalize and anticipate future changes in spoken and unspoken customer needs such as their goals, values, preferences and expectations.

2. Aligning strategies with customer needs 410: The ability to gain business results over time by applying knowledge of market maturity, customer needs and customer value to make decisions on what value to provide to specific customers.

3. Providing customer-centered leadership 415: The ability to tailor business systems to deliver superior value, and to model behaviors, create organizations, and establish rewards that lead employees in providing a superior TCE.

4. Creating, communicating and delivering a superior TCE 420: The ability to create or orchestrate products, services and solutions tailored to unique customer needs by involving customers from conception through solution, and by addressing the total customer experience.

5. Monitoring and responding to customer perceptions 425: The ability to measure the customers' perception of the value they receive, and to analyze and apply this information to improve products, services, internal processes and business performance.

6. Customers experience easy, flexible ways of doing business 430: The ability to provide value to customers by understanding and adhering to their preferences in doing business with the organization (e.g. terms & conditions, transaction type, delivery, scheduling, etc.), and by offering choice, control and customization in their access to information and expertise.

7. Customers experience competence, empathy and responsiveness they can count on 435: The ability to create the attitudes, motivation, competence, and organization structure for customers to experience seamless, prompt and effective closure on their interests.

8. Customers experience an ongoing relationship with the organization 440: The ability to create, nurture and personalize customer relationships by systematically developing, using and sharing customer histories including experiences, values, preferences, expectations and transaction information.

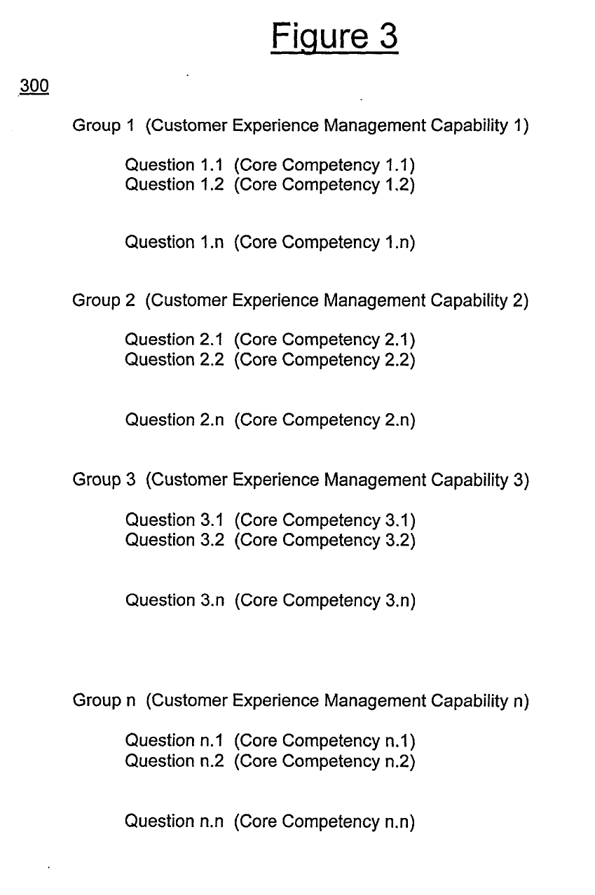

In one embodiment, the survey comprises a plurality of questions pertaining to the employees' perception of the organization's current TCE performance. Referring to FIG. 3, an outline of an exemplary survey 300, also referred to herein as a total customer experience capability assessment, in accordance with one embodiment of the present invention is shown. Survey 300 comprises a plurality of questions, wherein the questions (e.g., Questions 1.1 and 1.2) are divided into groups (e.g., Groups 1 and 2). It should be appreciated that there can be any number of questions and any number of groups. Embodiments of the present invention are not limited to specific numbers of questions or groups.

In one embodiment, one group corresponds to a customer experience management capability (e.g., customer experience management factor). In another embodiment, each group corresponds to a customer experience management capability (e.g., customer experience management factor). In one embodiment, one question corresponds to a core competency, wherein a core competency is a particular concern within the corresponding customer experience management capability. In another embodiment, each question corresponds to a core competency.

In one embodiment, the survey comprises two sections. In the present embodiment, the first section comprises a plurality of question groups corresponding to a customer experience management capability. The questions of the first section are intended to determine the organization's performance across each of the customer experience management capabilities represented in the survey. In one embodiment, the second section requires the survey participants to relatively rank each customer experience management capability in terms of importance to the organization's success.

At step 206, the survey data is compiled, wherein the survey data is characterized according to the plurality of customer experience management capabilities. In one embodiment, the data is entered into a database. In one embodiment, standard methods of survey data compilation are used to account for data errors and to ensure the quality of the data.

At step 208, the survey data is analyzed. In one embodiment, the data is analyzed to understand the correlations and links between specific groups and questions, to understand how the participants responded.

In one embodiment, the customer experience management capabilities are analyzed according to a corresponding maturity framework. The maturity framework is used to understand how advanced the organization is with respect to each customer experience management capability. In particular, this analysis allows organizations to determine their maturity level based on the structure, processes, measures and culture of the organization, and also aids in defining the requirements for increasing the organizations maturity level with respect to the customer experience management capabilities.

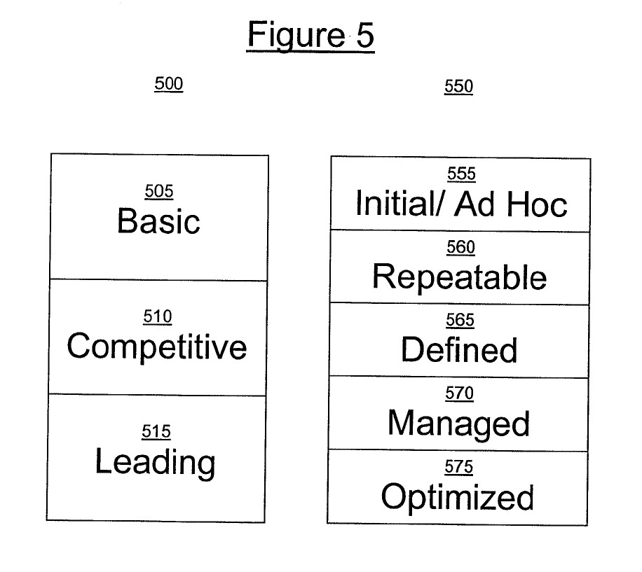

In one embodiment, the maturity framework is comprised of three maturity levels, as shown in maturity framework 500 of FIG. 5, and listed as follows:

1. Basic 505: Customer centered methods are applied to address target customer needs and business goals.

2. Competitive 510: Product, service and process decisions are influenced by a deep understanding of customer needs and market maturity. Value delivery enhancements are phased in over time.

3. Leading 515: The organization, suppliers and partners integrate activities in order to maximize customer value. Create and drive markets, and to optimize business performance and the total customer experience.

In another embodiment, the maturity framework is comprised of five maturity levels, as shown in maturity framework 550 of FIG. 5, and listed as follows:

1. Initial/Ad Hoc 555: Customer needs are not systematically considered in business planning or in product, service or solution planning and development.

2. Repeatable 560: Customer-centered methods are applied to address target customer needs and business goals.

3. Defined 565: Product, service and process decisions are influenced by a deep understanding of current customer needs and market maturity. Value delivery enhancements are phased in over time.

4. Managed 570: TCE is planned and managed. The organization, suppliers and partners integrate activities in order to maximize customer value. Management anticipates changes in market maturity and plans new value delivery activities.

5. Optimized 575: Create and drive new markets. Optimize business performance, the TCE and manage value delivery as a system.

It should be appreciated that either maturity framework 500 or 550 can be used to determine the maturity level of a customer experience management capability. For example, for use in future planning, an organization may desire a more detailed maturity framework, and thus select maturity framework 550. Alternatively, for presentations, an organization may desire a simpler maturity framework, and select framework 500.

Referring to FIG. 2, at step 210 a performance profile is generated for at least one of the plurality of customer experience management capability. The performance profile illustrates the maturity level and an importance level of each customer experience management capability. The performance profile emphasizes which customer experience management capabilities are important for the organization's success. Furthermore, the performance profile shows which capabilities are not performing well, allowing the organization to focus on critical improvement areas.

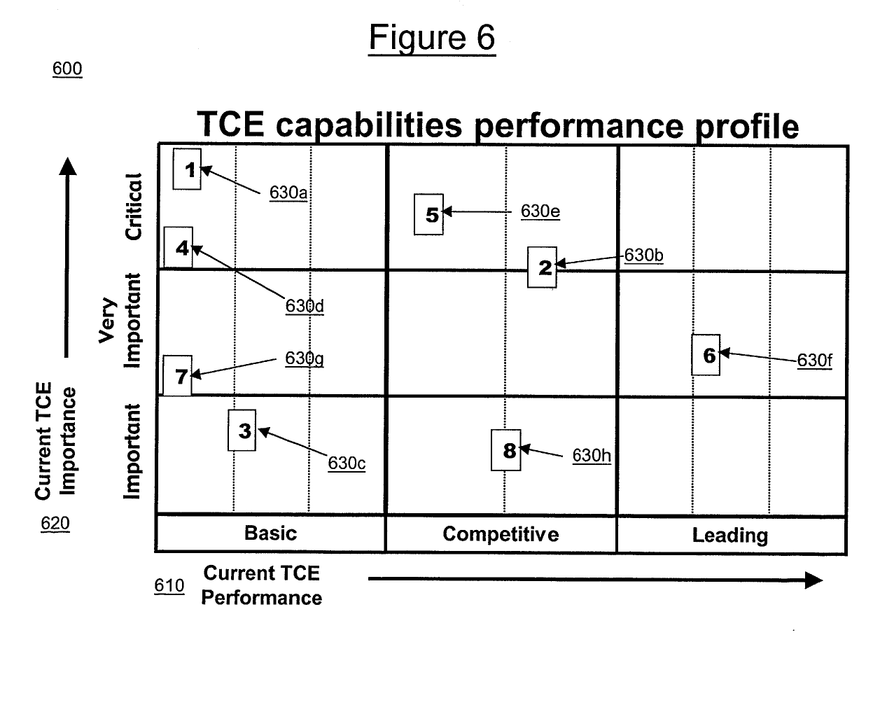

FIG. 6 is an illustration of an exemplary performance profile 600 showing a maturity level and an importance level of a plurality of customer experience management capabilities, in accordance with one embodiment of the present invention. Performance profile 600 comprises a horizontal axis 610 and a vertical axis 620. In one embodiment, horizontal axis 610 corresponds to the current TCE performance level (e.g., maturity level) of a customer experience management capability and vertical axis 620 corresponds to the current TCE importance level of a customer experience management capability.

Customer experience management capabilities 630a-h are plotted on performance profile 600, showing a maturity level and importance level for each capability. It should be appreciated that any number of capabilities can be plotted on performance profile 600, and that the present invention is not limited to the number of capabilities shown in the present embodiment.

For example, referring to capability 630a, employees rated capability 630a as critical to the organization's success, as indicated by its position with respect to vertical axis 620. However, employees rated its performance as basic (e.g., a low maturity level), as indicated by its position with respect to horizontal axis 610. Similarly, referring to capability 630f, employees rated capability 630f as very important to the organization's success, as indicated by its position with respect to vertical axis 620. Furthermore, employees rated its performance as leading (e.g., a high maturity level), as indicated by its position with respect to horizontal axis 610.

Performance profile 600 provides an organization with an understanding of its TCE performance for each customer experience management capability. Performance profile 600 also allows an organization to identify its highest return improvement opportunities based on objective data. In particular, performance profile 600 provides an easy to read and easy to understand metric for use in a TCE action planning process as described at FIG. 1.

Referring to FIG. 2, at step 212 a core competency profile is generated for at least one of the plurality of customer experience management capabilities. The core competency profile illustrates a performance level of at least one core competency within a corresponding customer experience management capability. The core competency profile details the performance of core competencies within a particular customer experience management capability.

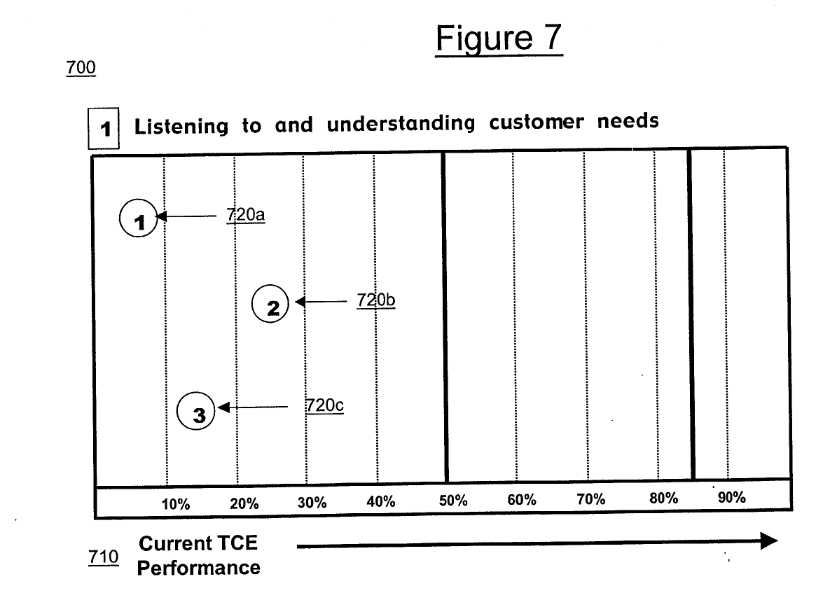

FIG. 7 is an illustration of an exemplary core competency profile 700 for a customer experience management capability showing a performance level of at least one core competency within the customer experience management capability, in accordance with one embodiment of the present invention. Performance profile 700 comprises a horizontal axis 710. In one embodiment, horizontal axis 710 corresponds to the current TCE performance level (e.g., maturity level) of a core competency within a customer experience management capability. In one embodiment, the current TCE performance level is shown as a percentage corresponding to a maturity level.

Core competencies 720a-c are plotted on core competency profile 700, showing a maturity level for each core competency. It should be appreciated that any number of core competencies can be plotted on core competency 700, and that the present invention is not limited to the number of core competencies shown in the present embodiment.

For example, referring to core competency 720a, employees rated its performance at under ten percent (e.g., a low maturity level), as indicated by its position with respect to horizontal axis 710. Similarly, referring to capability 720b, employees rated its performance at greater than twenty percent, as indicated by its position with respect to horizontal axis 710.

Core competency profile 700 provides an organization with an understanding of its TCE performance for each core competency. Core competency profile 700 also allows an organization to identify which core competencies contributed to the performance level of the corresponding customer experience management capability. In particular, core competency profile 700 provides an easy to read and easy to understand metric for use in a TCE action planning process as described at FIG. 1.

Using performance profile 600 (FIG. 6) and core competency profile 700 (FIG. 7) provide organizations with an understanding of the capabilities required for effective customer experience management and how these capabilities can be evolved over time. Organizations are able to gain an objective, in-depth perspective of their current performance on these capabilities and target the critical improvements needed to ensure their future business success. The organizations are provided with quantitative performance measures and qualitative feedback for tracking the effects of their improvement efforts over time.

The present invention provides a method and system for assessing an organization's current TCE performance. The present invention also provides a method and system that identifies the critical few highest leverage improvement opportunities with respect to providing superior TCE. The present invention provides a method and system that provides an objective and qualitative analysis of an organization's current TCE performance that supports top-down organizational change.

The present invention provides an organization with an understanding of the customer experience management capabilities required for effective customer experience management by providing the organization with an objective, in-depth perspective on their performance of these customer experience management capabilities and to target critical improvements for ensuring future business success.

The various embodiments of the present invention, a method for assessing performance of a total customer experience of an organization, are thus described. While the present invention has been described in particular embodiments, it should be appreciated that the present invention should not be construed as limited by such embodiments, but rather construed according to the below claims.

What is claimed is:

1. A method for assessing performance of a customer experience of an organization, said method comprising:
compiling survey data from at least one survey comprising questions corresponding to a core competency and said questions divided into question groups wherein at least one of said question group corresponds to one of a plurality of customer experience management factors; and
analyzing said survey data wherein at least one said customer experience management factor is analyzed according to a corresponding maturity level.

2. A method as recited in claim 1 wherein said survey is:
characterized according to said plurality of customer experience management factors;
completed by survey participants comprised of employees of said organization who provide a customer experience; and
used for assessing said customer experience based on performance of said plurality of customer experience management factors.

3. A method as recited in claim 1 further comprising generating a performance profile illustrating said maturity level and an importance level of at least one of said plurality of customer experience management factors.

4. A method as recited in claim 3 further comprising generating a core competency profile for at least one of said plurality of customer experience management factors, said core competency profile illustrating a performance level of at least one said core competency within said customer experience management factor.

5. A method as recited in claim 1 wherein said customer experience management factors comprise:
listening to and understanding customer needs;
aligning strategies with customer needs;
providing customer-centered leadership;
creating, communicating and delivering a superior customer experience;
monitoring and responding to customer perceptions;
customers experiencing easy and flexible ways of doing business;
customers experiencing competence, empathy and responsiveness they can count on; and
customers experience an ongoing relationship with said organization.

6. A method as recited in claim 1 wherein said maturity levels comprise:
basic;
competitive; and
leading.

7. A method as recited in claim 1 wherein said maturity levels comprise:
initial;
repeatable;
defined;
managed; and
optimized.

8. A method as recited in claim 1 further comprising identifying said survey participants.

9. A computer readable medium having computer readable code embodied therein for causing a computer to perform a method for assessing performance of a customer experience of an organization, said method comprising:
compiling survey data from at least one survey, said survey data characterized according to said plurality of customer experience management capabilities, said survey completed by survey participants providing a customer experience, said survey participants comprising employees of said organization, said survey for assessing said customer experience based on performance of a plurality of customer experience management capabilities, said survey comprising questions corresponding to a core competency and said questions divided into question groups wherein at least one of said question group corresponds to one of said plurality of customer experience management capabilities; and
analyzing said survey data such that at least one said customer experience management capability is analyzed according to a corresponding maturity level.

10. A computer readable medium as recited in claim 9 further comprising generating a performance profile illustrating said maturity level and an importance level of at least one of said plurality of customer experience management capabilities.

11. A computer readable medium as recited in claim 10 further comprising generating a core competency profile for at least one of said plurality of customer experience management capabilities, said core competency profile illustrating a performance level of at least one said core competency within said customer experience management capability.

12. A computer readable medium as recited in claim 8 further comprising identifying said survey participants.

13. A method for assessing performance of a customer experience of an organization, said method comprising:
identifying survey participants providing a customer experience, said survey participants comprising employees of said organization;
generating a survey, wherein said survey is for assessing said customer experience based on performance of a plurality of customer experience management factors, said survey comprising questions corresponding to a core competency and said questions divided into question groups wherein at least one of said question group corresponds to one of said plurality of customer experience management factors, said survey performed by at least one said survey participant;
compiling survey data from at least one said survey, wherein said survey data characterized according to said plurality of customer experience management factors; and
analyzing said survey data wherein at least one of said customer experience management factors is analyzed according to a corresponding maturity level.

14. A method as recited in claim 13 further comprising generating a performance profile illustrating said maturity level and an importance level of at least one of said plurality of customer experience management factors.

15. A method as recited in claim 14 further comprising generating a core competency profile for at least one of said plurality of customer experience management factors, said core competency profile illustrating a performance level of at least one said core competency within said customer experience management factor.

16. A method as recited in claim 13 wherein said customer experience management factors comprise:
listening to and understanding customer needs;
aligning strategies with customer needs;
providing customer-centered leadership;
creating, communicating and delivering a superior customer experience;
monitoring and responding to customer perceptions;
customers experiencing easy and flexible ways of doing business;
customers experiencing competence, empathy and responsiveness they can count on; and
customers experience an ongoing relationship with said organization.

17. A method as recited in claim 13 wherein said maturity levels comprise:
basic;
competitive; and
leading.

18. A method as recited in claim 13 wherein said maturity levels comprise:
initial;
repeatable;
defined;
managed; and
optimized.

19. A method for generating a survey for assessing performance of a customer experience of an organization, said method comprising:
identifying at least one customer experience management factor that identifies an area of customer experience, wherein said customer experience management factor can be analyzed according to a maturity level;
identifying a core competency for at least one said customer experience management factor, said core competency is a particular concern within said customer experience management factor; and
generating a plurality of questions, wherein at least one question corresponds to said core competency.

20. A method as recited in claim 19 wherein said survey is displayed on display screen of a computer system.

21. A method as recited in claim 20 wherein a survey participant participates in said survey by interacting with said computer system.
